(19) United States
(12) Patent Application Publication
(10) Pub. No.: US 2022/0056385 A1
(43) Pub. Date: Feb. 24, 2022

(54) BUFFERED VINEGAR PRODUCTS WITH REDUCED COLOR, ODOR, AND FLAVOR AND METHODS OF PRODUCING THE SAME

(71) Applicant: KERRY LUXEMBOURG S.A.R.L., Luxembourg (LU)

(72) Inventors: Richard S. HULL, Athens, GA (US); Bilal Kirmaci, Springfield, MO (US); Romeo Toledo, Hull, GA (US); Mo Mui Toledo, Hull, GA (US); Kaushlendra Tingi, Athens, GA (US)

(73) Assignee: KERRY LUXEMBOURG S.A.R.L., Luxembourg (LU)

(21) Appl. No.: 16/998,635

(22) Filed: Aug. 20, 2020

(51) Int. Cl. C12J 1/00; B01D 15/14; B01D 15/18; B01D 15/20; B01D 15/24; A23L 5/20

(52) U.S. Cl. CPC C12J 1/00; B01D 15/14; B01D 15/1871; A23V 2002/00; B01D 15/24; A23L 5/273; B01D 15/20

(57) ABSTRACT

Embodiments of the present disclosure provide improved buffered vinegar products having substantially reduced color, odor, and flavor, and methods to produce the same. The methods include combining a buffered vinegar product with an activated carbon in a batch or continuous process. The methods can be configured to maintain a total acetate content of the buffered vinegar product.

### BACKGROUND

Vinegar is a widely-used ingredient in domestic cookery. It is also used in various applications in the food industry for its antimicrobial properties, ability to sequester ionic species to prevent color and flavor changes in foods, and as an acidulant and flavoring agent.

In spite of its known effectiveness in various applications in the food industry, vinegar carries a characteristic smell/odor that can detract from consumers' acceptance of food products having vinegar as an ingredient. This objectionable characteristic of vinegar is particularly obvious in packaged ready-to-cook raw meats, where a prominent vinegar smell may be detected when the package is opened.

Industrial vinegar is produced in a two-stage fermentation. In the first stage, carbohydrates found in the raw material are converted by yeast to ethanol. Then, acetic acid bacteria (e.g., Acetobacter and Gluconobacter) convert the ethanol into vinegar. The flavor of the vinegar depends on the distillation process for ethanol separation from the fermentation broth and the presence of microbial metabolite by-products of the two-step fermentation.

Vinegar may be used in the meat industry, for example, after neutralizing the acetic acid using a neutralizing agent such as sodium carbonate, sodium bicarbonate, potassium carbonate, potassium bicarbonate, or a combination thereof and adjusting the pH by addition of un-neutralized vinegar, yielding a buffered vinegar. In order to facilitate production of the buffered vinegar at locations far from the point of use, a concentrated form of the buffered vinegar may be used to minimize volume on storage and transportation. Processes for preparing buffered vinegar are described, for example, in U.S. Pat. Nos. 8,877,280 and 8,182,858, both of which are incorporated by reference herein in their entirety.

A process for concentrating neutralized vinegar typically involves a heating step to remove water. This heating step can result in color darkening because of heat-induced chemical reactions, and the product may acquire a smell that is characteristic of a “cooked” product and is a departure from the characteristic vinegar smell. Depending upon the food product in which the concentrated buffered vinegar is used, the color and/or smell may result in a deviation from acceptable norms of food product quality.

Accordingly, there is a need for a process for selectively removing compounds responsible for odor and color in concentrated buffered vinegars, which are generated during the neutralization and concentration processes, while maintaining desired properties of the buffered vinegar product, such as the total acetate content (acetate ions derived from acetate salts and acetic acid), pH, and titratable acidity (TA). Moreover, there is a need for such a process that can be used at a commercial or industrial scale to produce large quantities of a consistent buffered vinegar product that is colorless, odorless, and has a mild flavor.

### SUMMARY

The various embodiments of the present disclosure can provide improved buffered vinegar products having noticeably reduced color, odor, and flavor as compared to non-treated products, while having the same or substantially the same total acetate content of the non-treated products, and processes for achieving the improved buffered vinegar products.

In some embodiments, the buffered vinegar products of the present disclosure may have an almost water-like clarity (i.e., substantially clear/transparent and colorless) and a mild characteristic vinegar flavor. In some embodiments, a buttery flavor note may also be present.

In some embodiments, the buffered vinegar products of the present disclosure are produced by treating a buffered vinegar with an activated carbon. The buffered vinegar to be treated can be concentrated (e.g., by heat or other method) or un-concentrated (also referred to herein as “simple”). In some embodiments, the buffered vinegar to be treated is a concentrated buffered vinegar comprising a heat-concentrated neutralized vinegar adjusted to pH 5.6 by addition of un-neutralized vinegar (e.g., 300 grain vinegar) after concentration. In other embodiments, the buffered vinegar to be treated is a simple buffered vinegar comprising an un-concentrated neutralized vinegar adjusted to pH 5.6-6.0 by addition of un-neutralized vinegar (e.g., 300 grain vinegar). The concentration of commercial vinegar is expressed in “grain” defined as grams acetic acid per liter. In this regard, 300 grain vinegar has a density of 1.035 grams/cm³ thus it corresponds to about 28.9% w/w total acetic acid.

In some embodiments, the buffered vinegar products of the present disclosure are produced by passing the buffered vinegar through a bed of granular activated carbon (GAC), followed by filtration to remove eluted fine carbon particles. In other embodiments, the buffered vinegar products of the present disclosure are produced by mixing the buffered vinegar with powdered activated carbon (PAC) in a batch process, followed by filtration to separate the fine carbon particles from the clarified liquid.

In some embodiments, a ratio of a total acetate content (mass of acetate ions) in the un-treated vinegar product to that in the treated vinegar product is from 1:1 to 1:0.9. In other words, in some embodiments, the process is configured to maintain the same or substantially the same total acetate content (acetate ions derived from acetic acid and acetate salts) of the un-treated vinegar product.

In some embodiments, the mass ratio of the total acetate content can be from 1:1 to 1:0.95, or from 1:1 to 1:0.99.

In some embodiments, the treated vinegar product, made from commercially available 300 grain vinegar, is about 20% to about 30% w/w total acetate content (i.e., referred to herein as the sum of weights of acetate ions from unreacted acetic acid and acetate ions from salts produced during buffering of vinegar). Preferably the range of total acetate is from about 23% to about 27%.

In other embodiments, it is possible to use vinegar products with total acetate content higher than 30% w/w, which would produce the treated vinegar product with total acetate content higher than 27%.

In some embodiments, the carbon may be wetted (e.g., with water or diluted 300 grain vinegar) prior to use, such as for preventing the activated carbon particles from disintegrating and/or to prevent a pH spike in the fluid effluent from the carbon bed.

In some embodiments, the saturation point of the activated carbon in its adsorption of microbial metabolites may be determined by the clarity of the liquid effluent color as measured by the absorbance of the liquid using a spectrophotometer.

In some embodiments, the activated carbon is bituminous coal-based. In some embodiments, the activated carbon is coconut charcoal-based. In some embodiments, the activated carbon is wood charcoal-based. Other types and sources of carbon may also be used and are specifically contemplated. In addition, combinations of two or more types of carbon may be used (e.g., mixed together or separately) depending on their respective adsorption efficacies for specific chemical compounds of interest, which compounds may contribute to the color, odor, flavor, and/or total acetate content of the buffered vinegar product.

In some embodiments, the present disclosure provides a method of treating a vinegar product, the method including: mixing the vinegar product with activated carbon, wherein the vinegar product includes a concentrated buffered vinegar or a simple buffered vinegar; and separating the activated carbon from the vinegar product to yield a treated vinegar product, wherein a ratio of a total acetate content in the vinegar product to a total acetate content in the treated vinegar product is from 1:1 to 1:0.9.

In some embodiments, the activated carbon includes powdered activated carbon (PAC) or granular activated carbon (GAC).

In some embodiments, the treated vinegar product obtained from the process is substantially clear and colorless as measured by absorbance at 260 nm. In some aspects, the vinegar product and activated carbon are separated when the treated vinegar product has been determined to be substantially clear and colorless as measured by absorbance at 260 nm.

In some embodiments, the treated vinegar product obtained from the process has a mild vinegar flavor, as would be understood by a person of ordinary skill in the art.

In some embodiments, the concentrated buffered vinegar includes 300 grain vinegar neutralized by a neutralizing agent, concentrated by heat, and adjusted to pH 5.6.

In some embodiments, the simple buffered vinegar includes 300 grain vinegar neutralized by a neutralizing agent and adjusted to pH 6.0.

In some embodiments, the activated carbon may be derived from either coal, coconut charcoal, or wood charcoal. In other embodiments, the activated carbon may be derived from a source other than coal, coconut charcoal, or wood charcoal.

In some embodiments, the vinegar product treatment may consist of pumping the liquid through one or more columns each column comprising a bed of a single GAC, and when a plurality of columns are used, the bed in some of the columns may be of different GAC's.

In some embodiments, each column can be either 6-inch or a 12-inch inside diameter with a length to diameter ratio of about 17.5:1, to ensure consistent uniformity of liquid flow through each carbon particle in the bed and achieve a desired residence time.

In some embodiments, the vinegar product is separated from the activated carbon after a specified contact time to yield the treated product. The specified time can be selected based on whether the process is in batch or continuous. In some embodiments, the specified time is selected to achieve the removal of a predetermined amount of pyrazine compounds and/or a predetermined amount of -dione compounds. In some embodiments, the specified time is selected to maintain both adequate removal of undesirable compounds and retaining the total acetate content in the treated product.

In some embodiments, the vinegar product can be pumped through a column at a flow rate sufficient to provide an empty bed contact time (EBCT) of 70 or 120 minutes.

In some embodiments, the process may involve pumping the vinegar product through two or more columns in series.

In some embodiments. the vinegar product may be passed through two carbon bed columns in series with the first column filled only with coal GAC and the second column filled only with wood GAC. In other embodiments, the columns may be filled with layers of different GAC's. In a two column and two GAC types, the first column may be filled with 75% coal GAC and 25% wood GAC by weight, and the second column may be filled with 75% wood GAC and 25% coal GAC. In some embodiments, the first column contains 85% coal GAC and 15% wood GAC and the second column may be filled with 85% wood GAC and 15% coal GAC. The embodiments may include different combinations of layers of GAC's in the two carbon bed columns.

In some embodiments, the process includes a plurality of columns in one set and a plurality of sets with each set of columns containing only one type of GAC. A set of four columns with 3 filled only with coal GAC and one filled only with wood GAC would provide the same effect as a single column filled with 75% coal GAC and 25% wood GAC. The effectiveness of separation of un-wanted compounds from the processed liquid may be evaluated easily in a plurality of columns by sampling effluent from the column of interest.

In some embodiments, the process includes pumping the vinegar product through a GAC bed column, wherein the column is arranged to extend vertically in its axial direction; and the vinegar product is fed into the vertically arranged column at an entry point leading into a plenum chamber at the lowermost point of the column. The plenum is formed by locating a porous plate a short distance from the bottom of the column. The plate holds the carbon bed above the plenum and serves as a distributor to ensure uniform distribution of liquid flow throughout the whole cross-section of the cylindrical column. After being fed into the column, the vinegar product rises through the bed of GAC towards a top of the column in the axial direction. The vinegar product that has risen though the bed of GAC can be subsequently fed to a second or subsequent column having a bed of GAC, a filtering unit having one or more filters, or a collection tank.

In some embodiments, the vinegar product that has risen though the bed of GAC and exits near the top of the column and is subsequently fed to the second column at an entry point leading to a plenum chamber located near the bottom the second column. Flow then proceeds in the axial direction of the second column.

In some embodiments, the effluent of the last of the carbon bed columns is collected and filtered using a filter having a pore size 1 micron or less.

In some embodiments, the entrained carbon particles separated from effluent of the one or more columns, by filtering through a filter having a pore size of about 0.35 microns.

In some embodiments, a filtering unit can be used for separating the treated vinegar product from the activated carbon, the filtering unit comprising a plurality of filters. In some embodiments, each unit in the plurality of filters will be of a different pore size. In some embodiments, the multiple filters are plumbed in series.

In some embodiments, multiple columns are used, and the multiple columns may include a set 1 of a number “nc” of columns filled with coal GAC produced from coal and a set 2 of a number “nw” of columns filled with wood GAC produced from wood, and a corresponding time of contact equals “nc”×EBCT for the coal GAC and “nw”×EBCT for the wood GAC. In some embodiments, a total nc+nw may be from 2 to 10. In some embodiments, nc and nw are both integers greater than 1. However, it should be clear that the number of columns nc and nw are not particularly limited and are chosen to allow for selective separation of unwanted compounds in the buffered vinegar to be treated.

In some embodiments, the treatment consists of mixing the vinegar product with the activated carbon in a batch process. The extent of completion of the batch adsorption process can be followed by taking a sample of the liquid, filtering to remove the activated carbon and analyzing the clarified liquid for color and the compound of interest.

In some embodiments, the batch process includes mixing the vinegar product and the activated carbon under intermittent or constant slow agitation. The mixing under intermittent or constant agitation may take place for a time period of at least one day. The total contact time between the vinegar product and activated carbon in a batch may extend from one to ten days.

In some embodiments, the batch process includes two stages. In the first stage the vinegar product is mixed with powdered activated carbon (PAC) in a 1:1 ratio of vinegar product to dry coal PAC by weight. The second stage includes mixing the drained vinegar product from the first stage with dry wood PAC in a 1:1 ratio by weight. In other embodiments, the first stage of the batch process can use ratios by weight of vinegar product to coal GAC of 1:0.75, 1:0.85, 1:0.95 or 1:1 depending on the effective length of contact between the vinegar product and coal GAC. The second stage of the batch process may use the ratio by weight of vinegar product drained from the first stage to dry GAC of 1:0.75, 1:0.85, or 1:0.95, or 1:1 for wood GAC.

In some embodiments, the first stage and/or the second stage of the batch process may be repeated any number of times until a satisfactory color or extent of undesirable compound removal is achieved.

In some embodiments, the batch process includes filtration between the first stage and the second stage to remove activated carbon entrained in the treated vinegar product. In some embodiments, the batch process includes filtration to separate activated carbon contained in the vinegar product obtained in the second stage of the process.

In some embodiments, the process includes repeating a number of times the first or second stages of the batch process until the desired product attributes are obtained.

In some embodiments, the filters each have a pore size of about one micron or less.

In some embodiments, the GAC is pulverized to a powder form to produce the PAC.

In some embodiments, the content or level of one of the aroma causing compound is periodically analyzed during the process. In some embodiments, the total acetate content is analyzed in samples taken during the process. In some embodiments, the clarity of the liquid effluent color as measured by the absorbance of the liquid using a spectrophotometer is analyzed in samples taken during the process. In some embodiments, the flow rate or contact time may be adjusted during the process to determine the appropriate process termination time based on achievement of a predetermined color clarity and adequate removal of a compound of interest.

In some embodiments, the present disclosure provides a treated vinegar product obtained by any of the embodiments disclosed above.

In some embodiments, the present disclosure provides a treated vinegar product having reduced color, odor, and flavor, produced by a process that includes providing a vinegar product to be treated; combining the vinegar product with activated carbon, wherein the vinegar product includes a concentrated buffered vinegar or a simple buffered vinegar, and wherein the activated carbon includes powdered activated carbon (PAC) or granular activated carbon (GAC); and separating the activated carbon from the vinegar product after a specified time, yielding the treated vinegar product, wherein a ratio of a total acetate content in the vinegar product to a total acetate content in the treated vinegar product is from 1:1 to 1:0.9. In some embodiments, the ratio of the total acetate content in the vinegar product to the total acetate content in the treated vinegar product is from 1:1 to 1:0.99. In other words, in some embodiments, the total acetate content of the treated vinegar product is the same or substantially the same as the vinegar product to be treated.

In some embodiments, the present disclosure provides a treated vinegar product that is substantially clear and colorless as measured by absorbance at 260 nm.

In some embodiments, the present disclosure provides a treated vinegar product having a total acetate content of from 20% to 30%.

In some embodiments, the present disclosure provides a treated vinegar product having a mild vinegar flavor.

In some embodiments, the treated vinegar product is added to a meat or meat product. In some embodiments, the treated vinegar product is added to a meat or meat product in a sufficient quantity to preserve the meat or meat product. In some embodiments, after the treated vinegar product is added to the meat or meat product, a package containing the meat or meat product is sealed within a substantially airtight package or is hermetically sealed within a package. In some embodiments, the treated vinegar product is stored in a sealed container for bulk sale to a consumer.

Additional features and advantages of the present disclosure are described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The application file contains at least one drawing executed in color. Copies of this patent application publication with color drawing(s) will be provided by the Office upon request and payment of the necessary fee.

The foregoing summary, as well as the following detailed description of certain embodiments of the application, will be better understood when read in conjunction with the appended drawings. For the purposes of illustrating the systems and methods of the present application, there are shown in the drawings preferred embodiments. It should be understood, however, that the application is not limited to the precise arrangements and instrumentalities shown. In the drawings:

FIG. 1 shows a schematic of an illustrative system for activated carbon treatment in a continuous process, according to some embodiments of the disclosure;

FIG. 2 shows a schematic of an illustrative system for activated carbon treatment in a batch process, according to some embodiments of the disclosure;

FIG. 3 shows a schematic of an illustrative filtration system for removal of entrained carbon from the treated product, according to some embodiments of the disclosure;

FIG. 4 shows the color difference between untreated and activated carbon-treated samples of concentrated buffered vinegar;

FIG. 5 shows the color difference between untreated and activated carbon-treated samples of simple buffered vinegar;

FIG. 6 shows a schematic of an illustrative system for activated carbon treatment in a continuous process, according to some embodiments of the disclosure, and which was used in Example 11;

FIG. 7 shows cumulative production of the final treated product during 2-stage column testing in Example 11;

FIG. 8 shows changes in pH and TA (titratable acidity) during the entire 2-stage column testing in Example 11;

FIG. 9 shows the appearance of the feed concentrated buffered vinegar (first bottle on left) and intermediate products sampled as the testing progressed (second bottle from the left and the rest towards the right in chronological time) in Example 11;

FIG. 10 shows a schematic of an illustrative system for activated carbon treatment in a continuous process, according to some embodiments of the disclosure, and which was used in Example 12;

FIG. 11 shows a chart of pH and TA during stepwise 2-stage column testing according to Example 12; and

FIG. 12 shows the appearance of the products as testing progressed in Example 12.

### DETAILED DESCRIPTION

It is to be understood that both the foregoing general description and the following detailed description are exemplary and are intended to provide further explanation of the claims. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

As used herein, “about,” “approximately,” “substantially” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term and “substantially” and “significantly” will mean plus or minus >10% of the particular term. “Comprising” and “consisting essentially of” have their customary meaning in the art.

Any range will be understood to encompass and be a disclosure of each discrete point and subrange within the range.

As explained above, the known processes for concentrating neutralized vinegar beyond the limits of what can be attained by freeze concentration, typically involve a heating step, which can result in color darkening because of heat-induced chemical reactions. Further, the product may acquire a smell that is characteristic of a “cooked” product and is a departure from the characteristic vinegar smell. Depending upon the food product in which the concentrated buffered vinegar is used, the color and/or smell may result in a deviation from acceptable norms of food product quality.

The present disclosure addresses such problems and can provide a decolorized buffered vinegar product with a mild characteristic vinegar flavor. The removal of color from the buffered vinegar (concentrated or simple) according to embodiments of the present disclosure may be performed using an adsorption process, such as an activated carbon adsorption process. Preferably, the color removal process can also remove secondary microbial metabolites present in the unprocessed vinegar that is used to make the buffered vinegar.

Further, the processes disclosed herein can be configured to maintain a total acetate content (percent acetate ion by weight in unreacted acetic acid and acetate ions in salts produced by buffering of the vinegar). In other words, it is preferred that the total acetate content is not changed by the treatment with activated carbon. For example, a ratio of a total acetate content in the untreated vinegar product to a total acetate content in the treated vinegar product can be from 1:1 to 1:0.9 (which corresponds to a range from the total acetate content being unchanged by the treatment to the total acetate content being decreased by about 10% by the treatment). The ratio of the total acetate content in the vinegar product to the total acetate content in the treated vinegar product can also preferably be from 1:1 to 1:0.95, or more preferably from 1:1 to 1:0.99.

In some embodiments, the total acetate content in the treated vinegar product is from about 20% to about 30%, and is preferably from about 23% to about 27%.

In other embodiments, it is possible to use vinegar products with acetate content higher than 30% for carbon treatment, which would produce the treated vinegar product with total acetate content higher than 27%.

Activated carbon may be used in the present disclosure in a granular form or a powder form. Both have advantages and disadvantages. Powdered activated carbon (PAC) has a higher surface area, which can shorten the processing times. However, PAC is mainly used in batch processes and can require meticulous filtration to remove very fine particles from the treated liquid before it can be used in food products. Although filters with very fine pores are commercially available, the very small particles clog the pores resulting in rapid decay of filtrate flow requiring frequent filter replacement. On the other hand, granular activated carbon (GAC) may be used in a batch or continuous process with less problems of filtrate flow discontinuity because of the larger particle size. In a continuous process, a food product that needs to be treated is pumped through a packed cylindrical layer of activated carbon referred to as a carbon bed. A cylindrical configuration of the bed is generally used to simplify achievement of uniform fluid velocity past all particles in the bed. After the active adsorption surfaces in the carbon are saturated with the adsorbate, the process is terminated and the spent GAC may be regenerated for reuse. In some embodiments, in order to avoid handling of activated carbon and/or to facilitate disposal of spent carbon, fixed carbon beds may be used, where the liquid to be treated is passed through the bed until the bed is saturated (e.g., saturated with colored constituents or other undesired compounds needed to be removed from the liquid).

Activated carbon useful in the present disclosure can be manufactured from different sources, such as, but not limited to, coal, coconut, wood, and any herbaceous plant material first by converting the cellulosic material to charcoal then activating the carbon to produce surfaces that can readily adsorb the compounds of interest. Coal being a fossil carbon simply needed to be activated to exhibit the required affinity for compounds that must be removed from the liquid subjected to the treatment. The methods for carbon activation may be different for different carbon types and expected performance. The different activated carbon types may be obtained from several commercial manufacturers. These different types of activated carbon may show different affinities for the chemical compounds to be removed from the buffered vinegar (odor-active components, color bodies, etc.), thus resulting in different adsorption capabilities for individual chemical compounds. Removal of color and flavor from buffered vinegar (concentrated or simple) may be achieved using one carbon type, or a combination of two or more different carbon types, which may be selected, for example, after screening the adsorption efficacy of the carbon types on the compounds of interest.

The use of more than one carbon type can be implemented by mixing the two or more types together in any mass ratio (e.g., when using two different GAC sources the ratios by weight for the two sources could be 0.9:0.1 to 0.1:0.9 and any combination there between), or by separately using the two or more type (e.g., in a continuous process, one column could have a bed of one type (or combination of types) of activated carbon, and another column could have a bed of a different type (or different combination of types) of activated carbon). In one embodiment, the treatment includes a combination of treating the vinegar product with GAC obtained from a coal source followed by treating with GAC obtained from a wood source.

The average particle size and specific surface area of the GAC is not particularly limited. In some embodiments, the GAC may have at least 90% of granules by weight between 12 mesh size (1.70 mm) and 40 mesh size (0.42 mm) with mean particle diameter of about 1.0 mm and specific surface area of in the range of about 1130 to 1750 m²/g or between 8 mesh size (2.36 mm) and 30 mesh size (0.60 mm) with mean particle diameter of 1.35 to 1.40 mm and specific surface area of in the range of about 1000 to 1200²/g. In some embodiments, a plurality of individual columns may have beds packed with GAC, and the average particle size, specific surface area, and pore size and pore volume distributions of the GAC in each bed may be independently chosen for each bed to be the same or different.

The average particle size and specific surface area of the PAC is not particularly limited. In some embodiments, the PAC may have a 24 to 34% of the particles by weight between 60 mesh size (0.250 mm) and at least 65 to 75% of particles by weight smaller than 325 mesh size (0.0425 mm) with mean particle diameter less than 1.0 mm and specific surface area in the range of about 1000 to 1500 m²/g. In some embodiments, a batch process will include separate, sequential steps of combining vinegar with PAC, and the PAC used in each step may have the same or different average particle size, specific surface area, and pore size and pore volume distributions.

The compounds responsible for the harsh flavor of raw vinegar produced by aerobic bacterial fermentation of ethanol were determined as follows. The type of vinegar formed from ethanol ferment is classified as “distilled vinegar.” Typically, the ethanol ferment contains a maximum of 12% w/w acetic acid. To produce a 300 grain (300 g acetic acid/L) industrial strength vinegar, the ethanol ferment is concentrated by freeze concentration, whereby water in the form of ice crystals is removed. A 300 grain freeze-concentrated vinegar was obtained from an industrial vinegar supplier. Table 1 shows amounts of chemical compounds present in three vinegar product samples produced therefrom. ND=not found; HNV=heat-concentrated neutralized vinegar (neutralized using a neutralizing agent comprising primarily a bicarbonate or carbonate of potassium and/or sodium); and HNV pH 5.6=HNV with pH adjusted to 5.6 by addition of 300 grain vinegar after concentration.

TABLE 1
Amounts of chemical compounds in vinegar product samples

| | 300 Grain | | HNV |
|---|---|---|---|
| Compound, ng/mL | Vinegar | HNV | pH 5.6 |
| Acetaldehyde | 9.65 | 0.29 | 120 |
| Methyl acetate | 5686 | 268 | 8226 |
| Ethyl acetate | 145974 | 59 | 52052 |
| Ethyl propionate | 5.2 | ND | Not reported |
| 2,3-Butanedione (diacetyl) | 4909 | 490 | 7583 |
| 3-Hydroxy-2-butanone (acetoin) | 45736 | 6797.7 | 2126 |
| 2-Ethyl-3,5-dimethylpyrazine | 3.8 | 0.78 | 79.2 |
| Furfural | 117 | 1.6 | Not reported |
| Tetramethylpyrazine | 3.2 | 1.52 | 61.3 |
| 2,3-Butanediol diacetate | 5 | ND | Not reported |
| Benzaldehyde | 226 | 4.72 | 212 |
| Alpha terpinol | 24.4 | ND | Not reported |
| Ethyl phenyl ethyl acetate | 20 | ND | Not reported |
| 3,5-Dimethylbenzaldehyde | 20.6 | ND | Not reported |

Flavor characteristics of the 300 grain vinegar and the heat-concentrated neutralized vinegar with pH adjusted to 5.6 are shown in Table 2. Appearance and odor characteristics of the vinegar samples were analyzed by an experienced 10-member sensory panel.

TABLE 2
Flavor characteristics of 300 grain vinegar and HNV pH 5.6

| Sample | Color | Odor |
|---|---|---|
| 300 Grain Vinegar | light yellow/gold | vinegar > fruity nail polish |
| | | remover > buttery/dairy |
| HNV pH 5.6 | dark gold/brown | brothy/malty > stinky socks/ |
| | | shoes > vinegar > buttery/dairy |

Gas Chromatography Olfactometry (GC-O) of the samples in Table 2 compared with constituent compounds listed in Table 1 shows the compounds that contributed to the odors of the three sample vinegars. The brothy flavor note in the HNV pH 5.6 may be caused by the presence of pyrazines such as 2-ethyl-3,5-dimethyl pyrazine. The 300 grain vinegar contained high levels of methyl acetate, ethyl acetate, 2,3-butanedione, and 3-hydroxy-2-butanone, consistent with the strong “fingernail polish remover” and “buttery/dairy” flavor notes. The HNV pH 5.6 sample contained pyrazines and short chain fatty acids such as 3-methyl butanoic acid (not listed in Table 1) causing rancid/fecal flavor notes.

Treatments using activated carbon adsorption processes according to embodiments of the present disclosure can be used to modulate the undesirable color and flavor notes not only of 300 grain vinegar, but also of vinegar products derived from 300 grain vinegar, while maintaining the total acetate content. Various illustrative treatments according to certain embodiments of the present disclosure are described in the Examples below. In the Examples, “concentrated buffered vinegar” refers to HNV pH 5.6, and “simple buffered vinegar” refers to simple buffered vinegar pH 6.0. The carbon dosage is specified as a percent (w/w) of concentrated or simple buffered vinegar product treated.

### EXAMPLES

### Example 1

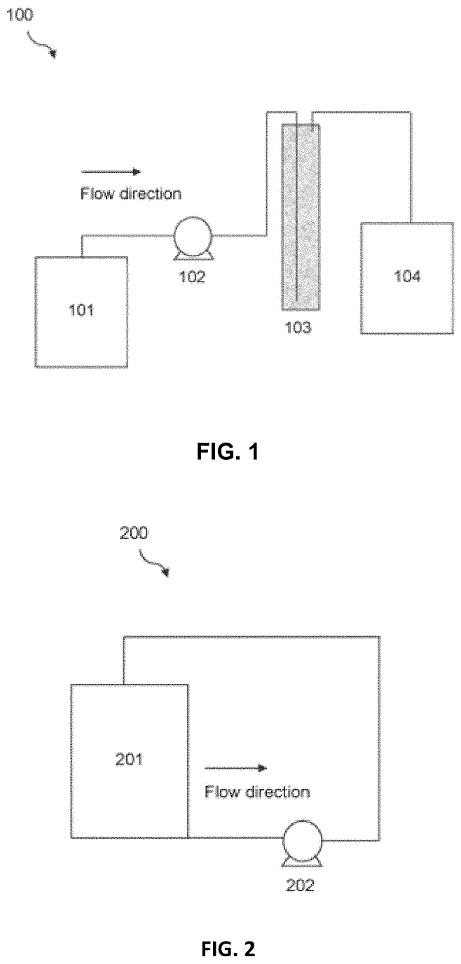

Granular activated carbon (GAC) was used to remove undesirable odor and color of concentrated buffered vinegar in a two-stage process. For this treatment, acid-washed GAC, HPC Maxx AW830 (Calgon Carbon, Moon Township, Pa.), was used in a 2-inch diameter 35-inch long stainless steel column. FIG. 1 shows a schematic of an illustrative column-based carbon treatment system 100 for a continuous process according to some embodiments of the present disclosure, which includes a reservoir 101, a pump 102, a column 103, and a collection tank 104. The GAC can be wetted (e.g., with water and/or diluted 300 grain white distilled vinegar) for at least 24 hours. In some embodiments, vinegar may be preferred for the wetting to prevent a decline in titratable acidity of concentrated buffered vinegar. Industrial strength vinegar, here 300 grain vinegar, was diluted with purified water to have 5-10% acidity and used to wet the GAC. In other embodiments another high grain vinegar, such as 200 grain vinegar, may be similarly diluted, or a standard strength vinegar may be used for wetting. The column was filled with dry carbon first, then wetting solution was pumped. After 24 hours, the column was drained. In alternative embodiment, carbon can be wetted in a container, drained, and then placed into the column. After draining the wetting solution, concentrated buffered vinegar was pumped into the column and the effluent was collected until desired reduction in absorbance was reached, indicating saturation of the GAC. The column was fed from the bottom and the product was overflowed from a short pipe (outlet) at the top. In other embodiments, the direction of flow inside the column could be reversed (e.g., the column may be fed from the top and the product can be drawn from the bottom using a longer pipe inside the column). The flow rate of the feed was calculated based on 70 minutes empty bed contact time (EBCT). The formula for the flow rate of concentrated buffered vinegar is given below.

$$Flow rate = \frac{Empty Bed Volume of Column , {m}^{3}}{E B C T , min}$$

At the end of the first stage process, spent carbon in the column was removed and discarded. Then, the column was filled with fresh pre-wetted GAC. (Alternatively, the column may be filled with unused GAC and the same wetting procedures may be followed as in the first stage). The effluent from the first stage treatment was pumped into the column at a flow rate 50% higher in EBCT than that used in the first stage process. When all the first stage effluent was passed through the second stage column, the resulting second stage effluent was then filtered through a 0.45 micron filter (EMD Millipore HVLP09050) on a Buchner funnel under vacuum, or a 1 micron polypropylene filter cartridge (Pentek DGD-2501) in a Pentek Big Blue Housing. For Test #1, the carbon dosages were 2% and 2.85% for the first and second stages, respectively. For Test #2, the carbon dosages were 2% and 4% for the first and second stages, respectively.

### Example 2

Powdered activated carbon (PAC) was used to remove odor and color of concentrated buffered vinegar. For this test, Pulsorb WP640 (Calgon Carbon, Moon Township, Pa.) (abbreviated in the Tables below as “PS”) was used. Concentrated buffered vinegar was mixed with PAC at 5% (Test #3) and at 9% (Test #4) concentration. To prevent change in the titratable acidity, industrial strength, 300 grain vinegar, was added to the concentrated buffered vinegar prior to introduction of PAC. Carbon cake was formed over time, and the vinegar-PAC mix was agitated intermittently to prevent powder settlement. The PAC was in contact with the concentrated buffered vinegar for 1 day with constant agitation (Test #4) or 8 days with few agitations (e.g., agitation twice a day; Test #3). At the end of the process, the PAC was removed using a 0.45 micron filter (EMD Millipore HVLP09050) on a Buchner funnel under vacuum.

### Example 3

Granular activated carbon (GAC) was used to remove odor and color of concentrated buffered vinegar in a batch process. For this test, acid-washed GAC, HPC Maxx AW830 (Calgon Carbon, Moon Township, Pa.) was used (abbreviated in the Tables below as “HPC”). Concentrated buffered vinegar was mixed with GAC at 9% concentration (Test #5). To prevent change in the titratable acidity, industrial strength, 300 grain vinegar, was added to the concentrated buffered vinegar prior to introduction of GAC. The vinegar-GAC mix was recirculated for 1 to 3 days using a diaphragm pump to prevent carbon granules from settling. At the end of the process, the GAC was removed using a series of filters having different pore sizes, including a 5 micron polypropylene filter cartridge (H2O Distributors LF-PP-005-508-B), a 1 micron polypropylene filter cartridge (Pentek DGD-2501), and a 0.35 micron pleated filter cartridge (Flow-Max FM-BB-20-035), each in a Pentek Big Blue Housing.

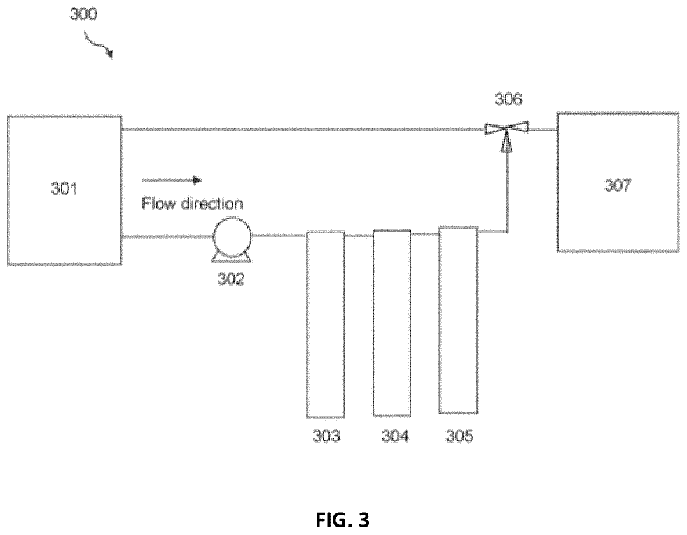

FIG. 2 shows a schematic of an illustrative carbon treatment system 200 for a batch process according to some embodiments of the disclosure, which includes a reservoir 201 and a pump 202. In other embodiments, the flow direction may be reversed. FIG. 3 shows a schematic of an illustrative filtration system 300 for removal of carbon from treated product, comprising a reservoir 301, a pump 302, three cartridge filters 303, 304, 305 each in a housing, a valve 306, and a collection tank 307 for effluent. Filtration system 300 may be used to remove carbon from product produced in either a batch process or a continuous process. The number of the filters in this system can be increased or decreased, for example, depending on the concentration of carbon particles floating in the effluent from the final filter. In some embodiments, a portion of the filter effluent may be circulated back to the reservoir for a period of time to allow carbon cake to build up on the filters to aid in carbon particle retention. Once a carbon cake layer is built up on the filters, and the filtrate is free of carbon particles, the rest of the effluent can then be passed through the filtration system to obtain the final desired product.

### Example 4

Concentrated buffered vinegar was treated with different types of activated carbon in powder form at 5% concentration. Pulsorb WP640 and PWA (Calgon Carbon, Moon Township, Pa.), two different types of coal-based powdered activated carbon (PAC) (abbreviated in the Tables below as “PS” and “PWA,” respectively), were used as-is (Test #6 and Test #7, respectively). OLC AW 12×40 (Calgon Carbon, Moon Township, Pa.), a type of coconut-based granular activated carbon (GAC) (abbreviated in the Tables below as “OLC”), was pulverized and used in a powder form (Test #8). Activated carbon was in contact with concentrated buffered vinegar for 8 days with intermittent agitation. Samples were transported to an outside laboratory during that period. At the end of the process, the PAC was removed using a 0.45 micron filter (EMD Millipore HVLP09050) on a Buchner funnel under vacuum.

### Example 5

Simple buffered vinegar was treated with HPC Maxx AW830 (Calgon Carbon, Moon Township, Pa.) (abbreviated in the Tables below as “HPC”) in a column as described in Example 1 at a carbon dosage of 1.5% (Test #9). GAC was wetted for at least 24 hours with diluted 300 grain vinegar containing 5-10% titratable acidity, drained, and placed into the column. Then, simple buffered vinegar was passed through the column (carbon bed) at a flow rate to have 70 minutes of EBCT. Simple buffered vinegar was treated through the column for only a single pass. At the end of the process, the collected product was filtered through a 0.45 micron filter (EMD Millipore HVLP09050) on a Buchner funnel under vacuum. The collected product and its control were analyzed for volatile compounds using headspace analysis and for absorbance at 260 nm.

### Example 6

Concentrated buffered vinegar was treated with HPC Maxx AW830 (Calgon Carbon, Moon Township, Pa.) (abbreviated in the Tables below as “HPC”) in a column that was scaled up based on the column described in Example 1. The height of the column was increased, while the height to diameter ratio of the carbon bed was kept the same. In some embodiments, a column that has been scaled up as described above may be divided into two or more sections (e.g., plumbed in a series) if needed (e.g., to account for limited ceiling height). GAC was wetted with diluted 300 grain white distilled vinegar having 5-10% titratable acidity for at least 24 hours. After 24 hours, the GAC was drained and then placed into the column. After filling the column, concentrated buffered vinegar was pumped into the column, and its flow rate was calculated based on the same velocity of the vinegar passing through the column as in the first stage of Example 1. Velocity was calculated by dividing the surface area of the column by flow rate of the vinegar. For this experiment, concentrated buffered vinegar was treated through the column for only a single pass. Total experiment time was about 72-80 hours. Samples of treated product were taken during the experiment at the end of Day 1, Day 2, and Day 3 (at the end of the experiment).

The treated vinegar was filtered through a system such as that shown in FIG. 3, which may comprise, for example, a series of filters having different pore sizes, including a 5 micron polypropylene filter cartridge (H2O Distributors LF-PP-005-508-B), a 1 micron polypropylene filter cartridge (Pentek DGD-2501), and a 0.35 micron pleated filter cartridge (Flow-Max FM-BB-20-035), each in a Pentek Big Blue Housing. The treated vinegar was sampled at various stages to have approximate carbon dosages of 5.5%, 4.0%, and 2.8% for Test #10 (Day 1), Test #11 (Day 2), and Test #12 (Day 3), respectively. The collected samples and their control (Control 3) were analyzed for volatile compounds using headspace analysis and for absorbance at 260 nm.

### Example 7

Concentrated buffered vinegar was treated in a column as described in Example 1 in a two-stage process. In the first stage, HPC Maxx AW830 (Calgon Carbon, Moon Township, Pa.) (abbreviated in the Tables below as “HPC”) was wetted at least 24 hours with diluted 300 grain vinegar containing 5-10% titratable acidity, drained, and placed into the column. After filling the column with the wetted GAC, concentrated buffered vinegar was pumped into the column at a flow rate equivalent to 70 minutes of EBCT. The carbon dosage for the first stage was 2.3% (Test #13). At the end of the first stage, the spent carbon in the column was discarded. OLC AW 12×40 (Calgon Carbon, Moon Township, Pa.) was wetted with diluted 300 grain vinegar containing 5-10% titratable acidity for at least 24 hours and placed into the column. The effluent from the first treatment stage was introduced into the second stage column at a flow rate to have 50% more EBCT than in the first stage. The carbon dosage for the second stage was 2.5% (Test #14). The collected product was filtered with a 1 micron polypropylene filter cartridge (Pentek DGD-2501) in a Pentek Big Blue Housing. The collected samples were analyzed for volatile compounds using headspace analysis and for absorbance at 260 nm. In alternative embodiments of the present disclosure using sequential carbon treatments, the concentrated buffered vinegar may be passed sequentially through two or more columns that are plumbed in a series and filled with the same or different types of carbon (sourced from coal, coconut, wood, etc.).

### Example 8

Concentrated buffered vinegar was treated with a wood-based granular activated carbon (GAC), Nuchar WV-B-30 (Ingevity, North Charleston, S.C.), at 2.5% concentration (Test #15) and 5.0% concentration (Test #16). The wood-based GAC was soaked in the concentrated buffered vinegar for 14 days with intermittent agitation (e.g., twice a day). At the end of the process, the GAC was separated from the concentrated buffered vinegar using a 0.45 micron filter (EMD Millipore HVLP09050) on a Buchner funnel under vacuum. All final filtrates were analyzed for absorbance at 260 nm. Filtrate from Test #15 was also analyzed for volatile compounds.

Results for Examples 1-8

Secondary microbial metabolites formed during fermentation of ethanol to vinegar were removed by adsorption on activated carbon. Heating also darkens the color of vinegar products and imparts a smell un-characteristic of vinegar smell. Adequacy of removal of unwanted microbial metabolites and heat-induced reaction products was found to correlate with color removal and was determined by measuring absorbance of the treated liquid using a spectrophotometer. A clear water-like liquid with a faint vinegar smell was produced when the buffered vinegar products were treated by the activated carbon adsorption processes.

Table 3 shows a comparison of the PAC and GAC treatments of simple and concentrated buffered vinegars from Examples 1-8. The results in Table 3 show that activated carbon treatments using either powdered (PAC) form or granular (GAC) form were effective in removing the color of the HNV pH 5.6 product by removing the colored constituents. The treatments may have also removed the compounds responsible for the “stinky socks/shoes” odor note. Thus, a clear product with just a slight vinegar note (and, in some examples, a slight buttery flavor note) was produced. In Table 3, TA=titratable acidity; Control 1 and Control 3=HNV pH 5.6 (different lots); Control 2=simple buffered vinegar pH 6.0. The tests #1, #2, #9, #10, #11, #12, #13, and #14 were GAC treatments in continuous process. The tests #3, #4, #6, and #7 were PAC and #5, #8, #15, and #16 were GAC treatments in batch process.

TABLE 3
Comparison of PAC and GAC treatments

| | pH | TA, % | Color | Odor |
|---|---|---|---|---|
| Test #1 | 5.40-5.80 | 3.50-4.00 | Clear | Slight vinegar, |
| | | | | slight buttery/dairy |
| Test #2 | 5.40-5.80 | 3.50-4.00 | Clear | Slight vinegar |
| Test #3 | 5.40-5.80 | 3.50-4.00 | Clear | Slight vinegar |
| Test #4 | 5.40-5.80 | 3.50-4.00 | Clear | Slight vinegar |
| Test #5 | 5.40-5.80 | 3.50-4.00 | Clear | Slight vinegar |
| Test #6 | 5.40-5.80 | 3.50-4.00 | Clear | Slight vinegar |
| Test #7 | 5.40-5.80 | 3.50-4.00 | Clear | Slight vinegar |
| Test #8 | 5.40-5.80 | 3.50-4.00 | Clear | Slight vinegar |
| Test #9 | 5.85-6.15 | 1.00-1.30 | Clear | Slight vinegar |
| Test #10 | 5.40-5.80 | 3.50-4.00 | Clear | Slight vinegar |
| Test #11 | 5.40-5.80 | 3.50-4.00 | Clear | Slight vinegar |
| Test #12 | 5.40-5.80 | 3.50-4.00 | Clear | Slight vinegar |
| Test #13 | 5.40-5.80 | 3.50-4.00 | Clear | Vinegar |
| Test #14 | 5.40-5.80 | 3.50-4.00 | Clear | Slight vinegar |
| Test #15 | 5.40-5.80 | 3.50-4.00 | Clear | Slight vinegar, |
| | | | | slight buttery/dairy |
| Test #16 | 5.40-5.80 | 3.50-4.00 | Clear | Slight vinegar |
| Control 1 | 5.40-5.80 | 3.50-4.00 | Light brown | Vinegar, malty, |
| | | | | buttery/dairy |
| Control 2 | 5.85-6.15 | 1.00-1.30 | Light amber | Vinegar, buttery/dairy |
| Control 3 | 5.40-5.80 | 3.50-4.00 | Light brown | Vinegar/pungent, |
| | | | | malty, buttery/dairy |

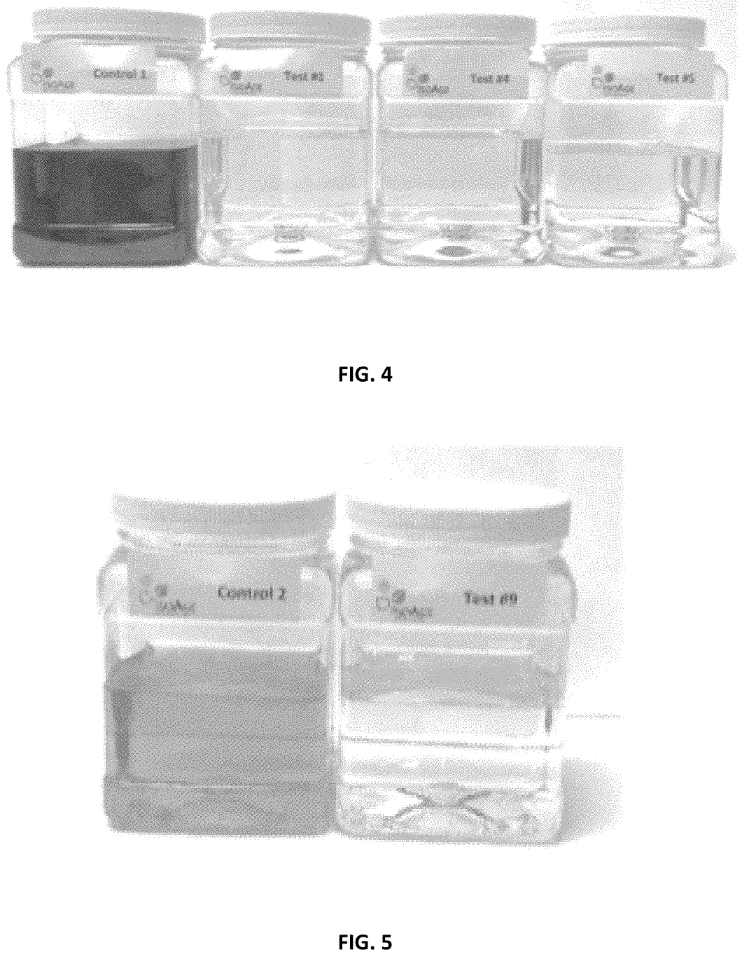

FIGS. 4 and 5 show the color differences between untreated and carbon-treated concentrated buffered vinegar samples (FIG. 4), and untreated and carbon-treated simple buffered vinegar samples (FIG. 5). FIG. 4 shows, from left to right: Control 1: HNV pH 5.6; Test #1: HPC Maxx AW830 in a continuous system at 2% and 2.85%; Test #4: Pulsorb WP640 in a batch system at 9%; and Test #5: HPC Maxx AW830 in a batch system at 9%. FIG. 5 shows, from left to right: Control 2: simple buffered vinegar pH 6.0; and Test #9: HPC Maxx AW830 in a continuous system at 1.5%.

Spectral scanning was used to evaluate the treated product color. A UV-Vis spectrophotometer (UV-2450, Shimadzu) was used to measure absorbance of concentrated buffered vinegar and decolorized concentrated buffered vinegar at wavelengths from 210 nm to 500 nm. Lower absorbance values at a given wavelength indicate that the material contains fewer compounds exhibiting visible color. For instance, deionized water, which is transparent and clear, had 0-0.001 absorbance at wavelengths from 210 nm to 500 nm. Table 4 shows the absorbances measured for GAC- and PAC-treated concentrated buffered vinegars. The GAC treatment process was on a vertically oriented cylindrical packed carbon bed while the PAC treatment was a batch process. Percentages in column headings in Table 4 indicate the actual carbon dose as percent of the sum of weights of carbon and liquid product recovered. In the Table 4, the Tests #1, #2, and 5 are continuous processes and Tests #3 and #4 are batch processes. The tests #1 and #2 were GAC treatments in continuous process. The tests #3 and #4 were PAC treatments and #5 was GAC treatment in batch process.

TABLE 4
Evaluation of treated product color

| | | GAC | | | PAC | |
|---|---|---|---|---|---|---|
| | | Test | Test | Test | Test | Test |
| | | #1 | #2 | #5 | #3 | #4 |
| Wavelength, | Control | Two stage | Two stage | HPC | Pulsorb | Pulsorb |
| nm | 1 | 2%-2.85% | 2%-4% | 9% | 5% | 9% |
| 210 | 4.318 | 3.569 | 3.478 | — | 3.569 | 3.438 |
| 250 | 4.318 | 0.605 | 0.564 | 0.717 | 0.728 | 0.588 |
| 300 | 3.158 | 0.157 | 0.147 | — | 0.191 | 0.144 |
| 350 | 1.844 | 0.04 | 0.038 | — | 0.058 | 0.064 |
| 400 | 1.042 | 0.008 | 0.007 | — | 0.009 | 0.012 |
| 450 | 0.663 | 0.003 | 0.002 | — | 0.001 | 0.005 |
| 500 | 0.436 | 0 | 0 | — | 0 | 0.003 |

Table 5 shows results from headspace analysis of decolorized and deodorized concentrated buffered vinegars. Pyrazines formed during heat evaporation of neutralized vinegar were removed by the PAC and GAC powder adsorption treatments. Two-stage treatment of the HNV pH 5.6 with GAC reduced the level of diacetyl in the product to 1190 ng/mL and acetoin to 1968 ng/mL. Treatment with Pulsorb PAC reduced diacetyl and acetoin to 389 ng/mL and 807 ng/mL, respectively. In the Table 5, the Test #1 is GAC treatment in continuous process. The tests #6 and #7 were PAC treatment and #8 was GAC treatment in batch process.

TABLE 5
Headspace analysis

| | | GAC | PAC | | GAC |
|---|---|---|---|---|---|
| | | Test | Test | PAC | Powder |
| | | #1 | #6 | Test | Test |
| | Control | Two stage | Pulsorb | #7 | #8 |
| Compound, ng/mL | 1 | 2%-2.85% | 5% | PWA 5% | OLC 5% |
| Acetaldehyde | 120 | 94 | 27 | 30 | 27.9 |
| Methyl acetate | 8226 | 16150 | 3477 | 3949 | 4715 |
| Ethyl acetate | 52052 | 8648 | 3659 | 4230 | 2226 |
| Ethanol | 10507 | 9287 | 5694 | 4794 | 4770 |
| 2,3-butanedione (diacetyl) | 7583 | 1190 | 389 | 390 | 352 |
| 3-hydroxy-2-butanone (acetoin) | 2126 | 1968 | 807 | 731 | 651 |
| 2-ethyl-5-methylpyrazine | 14.6 | 0.52 | None | None | None |
| 2,3,5-trimethylpyrazine | 142 | 1.39 | None | None | None |
| 2-ethyl-3,6-dimethylpyrazine | 20.2 | None | None | None | None |
| 2-ethyl-3,5-dimethylpyrazine | 79.2 | 0.97 | None | None | None |
| Tetramethylpyrazine | 61.3 | 2.25 | None | None | None |
| Benzaldehyde | 212 | 9.7 | 26 | 31 | 27.3 |

Table 6 shows absorbance and headspace analysis of decolorized and deodorized simple buffered vinegar through continuous process and a control which was the untreated simple buffered vinegar. GAC treatment of simple buffered vinegar reduced the levels of acetaldehyde, methyl acetate, ethyl acetate, diacetyl, pyrazines, and benzaldehyde. However, GAC treatment increased the acetoin concentration. In the Table 6, the test #9 was GAC treatment in continuous process.

TABLE 6
Absorbance and headspace analysis

| | | GAC |
|---|---|---|
| | | Test |
| | Control | #9 |
| Compound, ng/mL | 2 | HPC 1.5% |
| Absorbance at 260 nm | 2.319 | 0.323 |
| Acetaldehyde | 37.2 | 14.5 |
| 2-methylpropanal | 15.8 | 5.5 |
| Methyl acetate | 135 | 63 |
| Ethyl acetate | 11321 | 2091 |
| Ethanol | 5371 | 3062 |
| 2,3-butanedione (diacetyl) | 3281 | 2149 |
| 2,3-pentanedione | 0 | 0 |
| Methyl pyrazine | 34.9 | 24.8 |
| 3-hydroxy-2-butanone (acetoin) | 1854 | 2563 |
| 2,5(and 6)-dimethylpyrazine | 37.4 | 17.6 |
| Trimethylpyrazine | 206 | 117 |
| 3-ethyl-2,5-dimethylpyrazine | 0.3 | 0.1 |
| 2-ethyl-3,5-dimethylpyrazine | 75 | 18.3 |
| Benzaldehyde | 32.2 | 3.2 |

Table 7 shows absorbance and headspace analysis of decolorized and deodorized concentrated buffered vinegar samples taken from various stages as described in Example 6, and the associated control. As carbon dosage decreased, absorbance of the treated concentrated buffered vinegar increased. The same trend was also observed for acetaldehyde, methyl acetate, ethyl acetate, ethanol, diacetyl, acetoin, and benzaldehyde concentrations in the GAC-treated concentrated buffered vinegar samples. In the Table 7, the tests #10, #11, and #12 were GAC treatments in continuous process.

TABLE 7
Absorbance and headspace analysis

| | | GAC | GAC | GAC |
|---|---|---|---|---|
| | | Test | Test | Test |
| | Control | #10 | #11 | #12 |
| Compound, ng/mL | 3 | 5.5% | 4.0% | 2.8% |
| Absorbance at 260 nm | 4.061 | 0.41 | 0.53 | 0.66 |
| Acetaldehyde | 31.1 | 6.3 | 10.1 | 11.4 |
| 2-methylpropanal | 23.2 | 1.1 | 1.6 | 4.8 |
| Methyl acetate | 493 | 153 | 206 | 256 |
| Ethyl acetate | 22721 | 2225 | 3388 | 4028 |
| Ethanol | 5689 | 2845 | 3317 | 3593 |
| 2,3-butanedione (diacetyl) | 5664 | 264 | 686 | 914 |
| 2,3-pentanedione | 16.4 | None | None | None |
| Methyl pyrazine | 123 | None | None | None |
| 3-hydroxy-2-butanone (acetoin) | 6956 | 1016 | 2744 | 3834 |
| 2,5-dimethylpyrazine | 45.8 | None | None | None |
| Trimethylpyrazine | 118 | None | None | None |
| 2,3-dimethyl-5-ethylpyrazine | 9.19 | None | None | None |
| Benzaldehyde | 33.1 | 8.3 | 7.2 | 6.8 |

Table 8 shows absorbance and headspace analysis of decolorized and deodorized concentrated buffered vinegar treated using different types of GAC as described in Example 7. Coconut-based GAC in the second stage removed more acetoin than coal-based GAC in the second stage (see, e.g., Table 5 Test #1). However, Test #14 removed less diacetyl than Test #1. This may be related to coconut-based GAC having less porous structure as compared to coal-based GAC. Diacetyl removal was comparable between the coconut-based and coal-based activated carbon types when they were used in powder form (see, e.g., Table 5 Tests #6-8). In Table 8, the tests #13, and #14 were GAC treatments in continuous process.

TABLE 8
Absorbance and headspace analysis

| | GAC | GAC |
|---|---|---|
| | Test | Test |
| | #13 | #14 |
| | One stage | Two stage |
| Compound, ng/mL | 2.3% | 2.3%-2.5% |
| Absorbance at 260 nm | 0.792 | 0.627 |
| Acetaldehyde | 31.0 | 18.9 |
| 2-methylpropanal | 4.8 | 2.3 |
| Methyl acetate | 184 | 188 |
| Ethyl acetate | 13862 | 12659 |
| Ethanol | 6616 | 6044 |
| 2,3-butanedione (diacetyl) | 2699 | 1681 |
| 2,3-pentanedione | 0 | 0 |
| Methyl pyrazine | 50.9 | 37.53 |
| 3-hydroxy-2-butanone (acetoin) | 3045 | 1498 |
| 2,5(and 6)-dimethylpyrazine | 41.3 | 21.9 |
| Trimethylpyrazine | 151 | 56 |
| 3-ethyl-2,5-dimethylpyrazine | 1.0 | 0.3 |
| 2-ethyl-3,5-dimethylpyrazine | 3.3 | 0.8 |
| Benzaldehyde | 4.6 | 2.8 |

In an additional experiment, concentrated buffered vinegar was treated with OLC AW 12×40 (Calgon Carbon, Moon Township, Pa.) in the first stage and with HPC Maxx AW830 (Calgon Carbon, Moon Township, Pa.) in the second stage. To achieve absorbance similar to all-coal GAC-treated concentrated buffered vinegar at 260 nm, higher second stage carbon dosages were needed (2% and 4.15%, at the first and second stages, respectively), due to the less porous structure of coconut-based GAC as compared to coal-based GAC. Porous structure of the two different types of GAC may affect particle dimensions. Coconut-based GAC may be more compacted than coal-based GAC.

Table 9 shows a headspace analysis of concentrated buffered vinegars treated using a wood-based GAC. Pyrazines formed during concentration of neutralized vinegar by thermal evaporation were completely removed by the wood-based GAC (data not shown in Table 9). When the wood-based GAC was used to treat the concentrated buffered vinegar in a column at an approximate carbon dosage of 2.8%, the effluent was browner in color as compared to the same feed-stock treated with coal-based GAC (Example 6, Test #12, Table 7). However, wood-based GAC may also be used in a sequential multi-stage process along with coal-based and/or coconut-based GAC. In Table 9, the tests #15 and #16 were GAC treatments in batch process.

TABLE 9
Absorbance and headspace analysis

| | GAC | GAC |
|---|---|---|
| | Test | Test |
| | #15 | #16 |
| Compound, ng/mL | 2.5% | 5.0% |
| Absorbance at 260 nm | 0.753 | 0.700 |
| Acetaldehyde | 72 | — |
| Methyl acetate | 14715 | — |
| Ethyl acetate | 6055 | — |
| Ethanol | 8698 | — |
| 2,3-butanedione (diacetyl) | 2576 | — |
| 3-hydroxy-2-butanone (acetoin) | 1911 | — |
| Benzaldehyde | 7 | — |

### Example 9

Tables 10 and 11 show compound reduction rankings for four different carbon types used to treat of two different vinegar products in batch process. Product #1=concentrated buffered vinegar neutralized with a neutralizing agent comprising primarily bicarbonate or carbonate of sodium; Product #2=concentrated buffered vinegar neutralized with a neutralizing agent comprising primarily bicarbonate or carbonate of potassium. OLC is a coconut-based activated carbon; CPG, PS, and PWA are coal-based activated carbons. For each treatment, the carbon concentration used was 5%, and the contact time was 8-9 days. For each compound, the different carbon types were ranked from 1=most removed (M) to 4=least removed (L). Delta (L-M) is the concentration difference of a compound between least (L) and most (M) reduction (ng/mL). Delta (control-M) is the concentration difference of a compound between the control and the treated sample with most (M) reduction (ng/mL). The control was untreated product.

TABLE 10
Product #1-Compound reduction rankings

| | | | | | | | Reduction |
|---|---|---|---|---|---|---|---|
| | | | | | Δ | Δ | Δ |
| | Carbon Samples | | | | (L − M) | (control − M) | (control − M) |
| Compound | OLC | CPG | PS | PWA | (ng/mL) | (ng/mL) | % |
| acetaldehyde | 1 | 2 | 4 | 3 | 5.9 | 87.9 | 80.6 |
| methyl acetate | 4 | 3 | 1 | 1 | 851 | 4517 | 58.8 |
| ethyl acetate | 1 | 4 | 2 | 3 | 1928 | 32876 | 96.0 |
| ethanol | 3 | 4 | 1 | 2 | 1631 | 8804 | 80.1 |
| diacetyl | 3 | 4 | 1 | 2 | 66 | 9522 | 98.2 |
| styrene | 1 | 2 | 3 | 4 | 5.3 | 5.3 | 59.1 |
| acetoin | 2 | 4 | 1 | 3 | 15.6 | 791 | 77.5 |
| benzaldehyde | 1 | 2 | 3 | 4 | 5.4 | 211.4 | 89.2 |
| SUM | 16 | 25 | 16 | 23 | | | |

TABLE 11
Product #2-Compound reduction rankings

| | | | | | | | Reduction |
|---|---|---|---|---|---|---|---|
| | | | | | Δ | Δ | Δ |
| | Carbon Samples | | | | (L − M) | (control − M) | (control − M) |
| Compound | OLC | CPG | PS | PWA | (ng/mL) | (ng/mL) | % |
| acetaldehyde | 2 | 4 | 1 | 3 | 10 | 93 | 77.5 |
| methyl acetate | 4 | 3 | 1 | 2 | 1238 | 4749 | 57.7 |
| ethyl acetate | 1 | 4 | 2 | 3 | 2440 | 49826 | 95.7 |
| ethanol | 1 | 2 | 4 | 3 | 924 | 5737 | 54.6 |
| diacetyl | 1 | 4 | 2 | 3 | 65 | 7231 | 95.4 |
| styrene | 2 | 4 | 1 | 3 | 7 | 43.7 | 60.1 |
| acetoin | 2 | 1 | 4 | 3 | 201 | 1520 | 71.5 |
| benzaldehyde | 2 | 4 | 1 | 3 | 7 | 186 | 87.7 |
| SUM | 15 | 26 | 16 | 23 | | | |

### Example 10

Concentrated buffered vinegar was treated with a wood-based GAC (Type: BGX, Calgon Carbon, Moon Township, Pa.) (abbreviated in the Tables below as “BGX”) in a column that was scaled up based on the column described in Example 1. The height of the column was increased, while the height to diameter ratio of the carbon bed was kept the same. In some embodiments, a column that has been scaled up as described above may be divided into two or more sections (e.g., plumbed in a series), if needed (e.g., to account for limited ceiling height). GAC was wetted with diluted 300 grain white distilled vinegar having 5-10% titratable acidity for at least 24 hours. After 24 hours, the GAC was drained and then placed into the column. After filling the column, concentrated buffered vinegar was pumped into the column, and its flow rate was calculated based on the same velocity of the vinegar passing through the column as in the first stage of Example 1. Velocity was calculated by dividing the surface area of the column by flow rate of the vinegar. For this experiment, concentrated buffered vinegar was treated through the column for only a single pass. The total experiment time was about 96-100 hours.

The treated vinegar was filtered through a system such as that shown in FIG. 3, which may comprise, for example, a series of filters having different pore sizes, including a 5 micron polypropylene filter cartridge (H2O Distributors LF-PP-005-508-B), a 1 micron polypropylene filter cartridge (Pentek DGD-2501), and a 0.35 micron pleated filter cartridge (Flow-Max FM-BB-20-035), each in a Pentek Big Blue Housing. The treated and filtered vinegar was sampled at the end of the experiment and corresponding carbon dosage was calculated as 3.7% (Test #17). The collected sample and its control (Control 4) were analyzed for volatile compounds using headspace analysis and for absorbance at 260 nm.

In Example 10, an intent of the GAC treatment was that the total acetate content of the control does not change. Accordingly, total acetate content of the liquid was measured during the treatment process using a Megazyme Acetate Kit according to standard laboratory protocol. The total acetate content of the control was 25.23%. The final treated and filtered product had a total acetate content of 23.45%. Thus, the total acetate content hardly changed during the GAC treatment (the total acetate content was reduced by about 7%, which corresponds to a ratio of 1:0.93).

Table 12 shows an absorbance and headspace analysis of concentrated buffered vinegar treated with the wood-based GAC BGX in Example 10. The wood-based GAC treated concentrated buffered vinegar had a higher absorbance at 260 nm than coal-based GAC treated concentrated buffered vinegar (Example 6, Tests #11 and #12, Table 7). The wood-based GAC treatment reduced the levels of acetaldehyde, methyl acetate, ethyl acetate, diacetyl, pyrazines, and benzaldehyde. Further, the wood-based GAC treatment reduced the diacetyl and acetoin concentration about 91% and 16%, respectively.

TABLE 12
Absorbance and headspace analysis

| | | GAC |
|---|---|---|
| | | Test |
| | Control | #17 |
| Compound, ng/mL | 4 | BGX 3.7% |
| Absorbance at 260 nm | 4.128 | 0.696 |
| Acetaldehyde | 103 | 12.7 |
| 2-methylpropanal | 31.2 | 5.6 |
| Methyl acetate | 715 | 418 |
| Ethyl acetate | 25729 | 10470 |
| Ethanol | 16113 | 6139 |
| 2,3-butanedione (diacetyl) | 7722 | 657 |
| 2,3-pentanedione | 12.1 | 0 |
| Methyl pyrazine | 30.7 | 0 |
| 3-hydroxy-2-butanone (acetoin) | 3622 | 3033 |
| Trimethylpyrazine | 71.9 | 0.7 |
| 3-ethyl-2,5-dimethylpyrazine | 0.6 | 0 |
| 2-ethyl-3,5-dimethylpyrazine | 6.7 | 0.1 |
| Benzaldehyde | 57.4 | 4.0 |

### Example 11

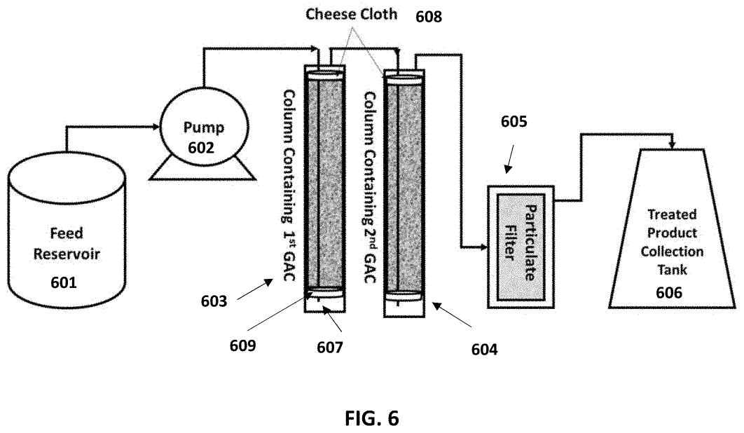

Concentrated buffered vinegar was treated in two columns connected (or plumbed) in series and each containing a different type of GAC. The experimental set-up used in Example 11 is shown in FIG. 6, which includes a feed reservoir 601, a pump 602, two types of GAC columns 603, 604 arranged vertically in the axial direction and connected (or plumbed) in series, a particulate filter 605, and a collection tank 606 for the final product. In particular the system shown in FIG. 6 is configured to eliminate preferential flow. Specifically, as shown, the liquid is fed into the column at entry point leading into the plenum chamber (defined at a top thereof by porous plenum plate 609) at the lowermost point (607) of the bottom of the column. After being fed, the vinegar product rises through the GAC bed towards the outlet located at the top of the column. This beneficially provides a consistent residence time and consistent contact time between the GAC and the vinegar product because preferential flow is eliminated.

The vinegar product that has risen though the bed of GAC of the first column and exited near the top of the column and was subsequently fed to the second column at an entry point leading to a plenum chamber located near the bottom the second column.

The vinegar product that has risen through the bed of GAC of the second column and exited near the top of the column was subsequently passed through particulate filter.

The two types of GAC was separately soaked for more than 2 days with 300 grain vinegar at 8% dilution. The first column contained 2.55 lb (1.16 kg) of soaked coal-based GAC (Type: HPC Maxx AW830, Calgon Carbon, Moon Township, Pa.) (abbreviated “HPC”) and the second column contained 2.13 lb (0.97 kg) of soaked wood-based GAC (Type: ACT BGX, Calgon Carbon, Moon Township, Pa.) (abbreviated “BGX”). The particulate filter was 0.35 micron (Type: Flow-Max Full-Flow (BB) 10″×4.5″, 0.35 Micron Filter, H2O Distributors, Marietta, Ga.). Concentrated buffered vinegar was used as the feed for this test.

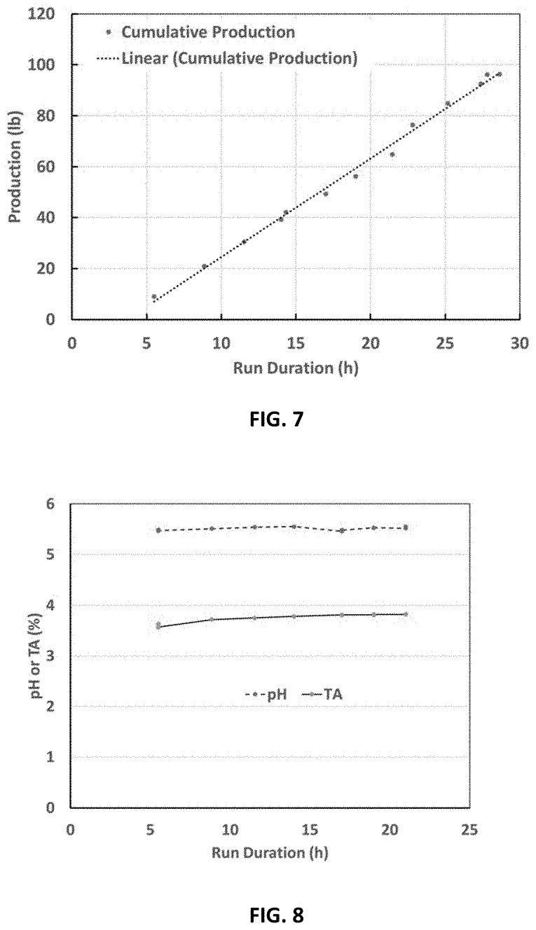

During the continuous 30-hour test, there was a 26.4% increase in the weight of the two GAC columns as 107.61 lb (48.81 kg) of concentrated buffered vinegar was passed through the columns at the rate of 0.056 lb/min (25.51 g/min). In the process, the concentrated buffered vinegar lost 1.2% of its weight (Table 13). After accounting for all the losses of concentrated buffered vinegar in columns and filtration system, 96.24 lb (43.65 kg) of final product was collected, which was about 90% yield. The remaining concentrated buffered vinegar stayed in the pores of the GAC; in the column, and/or in the cavity of the filtration system. During the entire 30 hours of testing, the cumulative production stayed linear, which indicates consistent removal of targeted chemical compounds from the concentrated buffered vinegar (FIG. 7).

Samples were collected about every 2 hours duration of the testing. The samples were tested for pH and TA (titratable acidity). The pH of the GAC treated and filtered product stayed in the range of 5.46 to 5.55, and there was no apparent pattern in the values of the pH measurements for the duration of the run (FIG. 8). Likewise, the measured value of the titratable acidity (TA) was 3.63 at the beginning, and increased to 3.82 as run progressed.

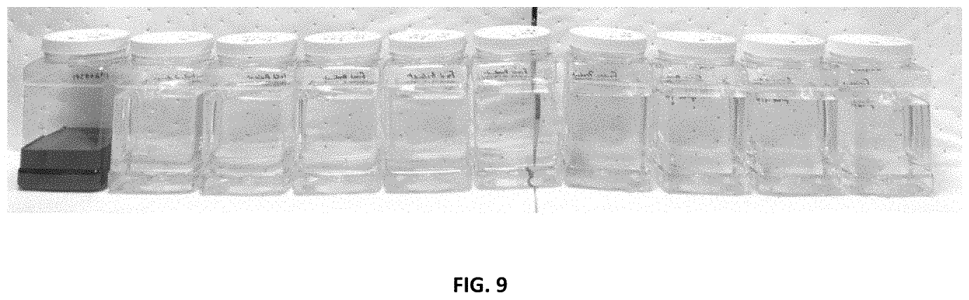

To start with, the product was almost looking like water. It appeared to be very slight yellowish after 4 to 5 hours, and remained that way for the remainder of the test duration. FIG. 9 shows the appearance of the feed concentrated buffered vinegar (first bottle on left) and the treated products sampled as the testing progressed (second bottle from the left and the rest towards the right in time order) in Example 11.

The total acetate content of the liquid was also measured during this example using a Megazyme Acetate Kit according to standard laboratory protocol within 5% accuracy. The treated product had a total acetate content of 25.35%, 25.83%, and 23.30% for the samples collected for 2 hours, 8 hours, and 26 hours. The total acetate content of the concentrated buffered vinegar was 25.23%. Thus, similar to Example 10, the total acetate content hardly changed during the GAC treatment (the total acetate content was reduced by about 7.5%, corresponding to a ratio of 1:0.925).

TABLE 13
Changes in the weight of GAC during continuous two column testing

| | Empty | Weight with | |
|---|---|---|---|
| | weight | wet GAC | GAC |
| Column Prep | (lb) | (lb) | (lb) |
| Column-1: HPC | 6.62 | 9.174 | 2.55 |
| Coal-based GAC | | | |
| Column-2: BGX | 6.62 | 8.752 | 2.13 |
| Wood-based GAC | | Total (lb) | 4.68 |
| | | Wet Carbon Dosage (%) | 4.35 |

| | | Weight with | | |
|---|---|---|---|---|
| | Empty | wet GAC | GAC | Weight |
| | weight | (lb) after | Collected | Gained |
| Post Testing | (lb) | draining | (lb) | (lb) |
| Column-1: HPC | 6.62 | 10.944 | 3.11 | 0.56 |
| Coal-based GAC | | | | |
| Column-2: BGX | 6.62 | 9.85 | 2.81 | 0.68 |

| | | |
|---|---|---|
| Wood-based GAC | Total Weight Gained by Both | 1.24 |
| | Columns Carbons (lb) | |
| | Total Weight Gained by per 100 | 26.39% |
| | pounds of Both Column's Carbons | |
| | (lb/lb) | |
| | Weight loss by per 100 pounds of | 1.15% |
| | HNV | |

### Example 12

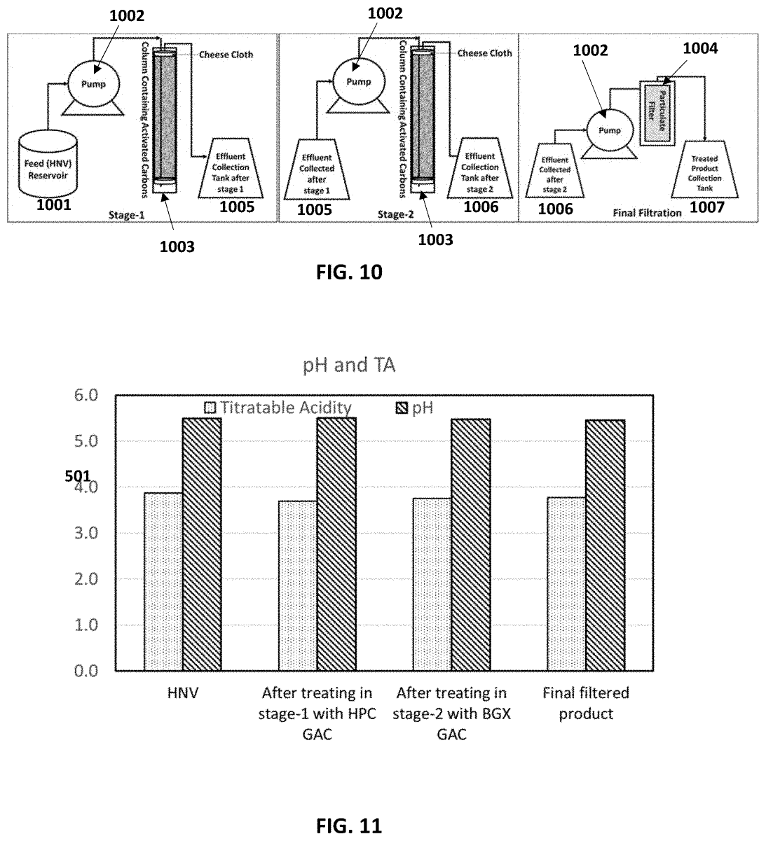

Concentrated buffered vinegar was treated in two stages in a column containing a different type of GAC for each stage. The experimental set-up used in Example 12 is shown in FIG. 10, which includes a feed reservoir 1001, a pump 1002, column 1003 containing one of two types of GAC, a particulate filter 1004, intermediate effluent collection tanks 1005, 1006, and a collection tank 1007 for the final product. Two different GACs were used in Example 12 for the first and second stage. Each GAC was soaked for more than 2 days with 300 grain vinegar at 8% dilution. The particulate filter was 0.35 micron (Type: Flow-Max Full-Flow (BB) 10″×4.5″, 0.35 Micron Filter, H2O Distributors, Marietta, Ga.). During the testing, concentrated buffered vinegar was used as the feed.

In the first stage, the column was filled with 2.03 lb (0.92 kg) of soaked a coal based GAC (Type: HPC Maxx AW830, Calgon Carbon, Moon Township, Pa.) (abbreviated “HPC”). The concentrated buffered vinegar was fed to the column at an entry point leading into a plenum chamber located at the lowermost point of the column. The effluent after the first stage was collected.

In the second stage, the effluent collected after the first stage (stage-1) was fed to the column containing 2.05 lb (0.93 kg) of soaked wood based GAC (Type: ACT BGX, Calgon Carbon, Moon Township, Pa.) (abbreviated “BGX”) (Table 14). The effluent after the second stage (stage-2) was collected. The effluent collected from the second stage was filtered using the particulate filter of 0.35 micron size to produce final filtered product. Whole experiment (stage-1, stage-2, and final filtration) was repeated two times (named as repetition 1 and repetition 2).

After each stage of treatment, about 92-94% of the treated product was recovered (Table 15).

The final filtered product had an average pH of 5.45 and TA of 3.77; whereas the concentrated buffered vinegar (also referred as HNV) had pH of 5.49 and TA of 3.87 (Table 16). The final filtered product was also tested for chemical compounds present in the headspace by solid-phase microextraction-gas chromatography-mass spectrometry (HS-SPME-GC-MS). The HNV had 23 different compounds present in it; however, only 6 compounds were present in the final filtered product. In the final filtered product, the main compounds present were the following: 3-hydroxy-2-butanone (1307 ng/mL), ethanol (6910 ng/mL), ethyl acetate (4955 ng/mL), methyl acetate (252 ng/mL), acetaldehyde (19 ng/mL), benzaldehyde (4 ng/mL), and 2-methylpropanal (3 ng/mL) (Table 17).

In addition, the final filtered product had only a fruity smell with very mild vinegar note, whereas the concentrated buffered vinegar (also referred as HNV) had a strong odor of vinegar>ethyl acetate>malty/nutty>dairy-buttery (Table 18). During the two-stage GAC treatment, all the pyrazines compounds responsible for broth smell and -dione compounds responsible for “fingernail polish remover and buttery/dairy” flavor notes were completely removed.

FIG. 11 shows the pH and TA of the HNV; after treating in the first stage with the HPC GAC; after treating in the second stage-2 with the BGX GAC; and the final filtered product.

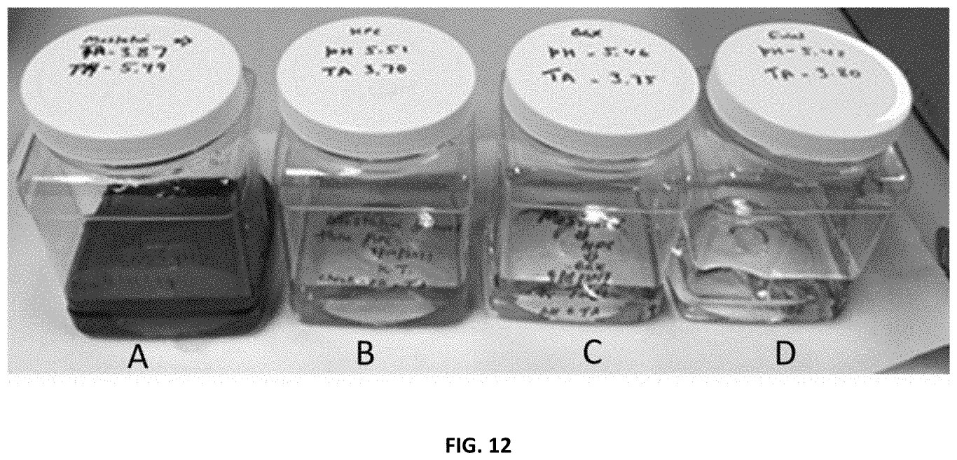

FIG. 12 shows the appearance of the product as testing progressed. In FIG. 12, A=HNV; B=product after the first stage; C=product after second stage; and D=final product after particulate matter filtration.

In addition, an intent of the GAC treatment was that the total acetate content of the control did not change during the GAC treatment. The results showed that the total acetate content of the control was 25.23%, which changed to 23.50 due to the GAC treatment (the total acetate content was reduced by about 6.9%, corresponding to a ratio of 1:0.931).

TABLE 14
GAC loading weight during two stage column testing

| | Repetition 1 | Repetition 2 | | |
|---|---|---|---|---|
| | Weight of wet | Weight of wet | | |
| | GAC in | GAC in | | Percent |
| | Column | Column | Mean | loading |
| Column Prep | (lb) | (lb) | (lb) | (%) |
| Stage-1: | 1.81 | 2.25 | 2.03 ± 0.31 | 5.63 |
| HPCGAC | | | | |
| Stage-2: | 1.91 | 2.18 | 2.05 ± 0.19 | 6.22 |
| BGX GAC | | | | |

TABLE 15
Weights of HNV input and output after each stage

| | Repetition 1 | Repetition 2 | | |
|---|---|---|---|---|
| | Weight | Weight | Mean | Recovery |
| Stage | (lb) | (lb) | (lb) | (%) |
| Input HNV | 35.93 | 36.15 | 36.04 | |
| Output after treating in | 32.77 | 33.13 | 32.96 | 91.43 |
| stage-1 with HPC GAC | | | | |
| Output after treating in | 30.55 | 31.25 | 30.90 | 93.76 |
| stage-2 with BGX GAC | | | | |

TABLE 16
pH and Titratable acidity for treated products

| | Repetition 1 | | Repetition 2 | | Mean | |
|---|---|---|---|---|---|---|
| | Titratable | | Titratable | | Titratable | |
| | Acidity | | Acidity | | Acidity | |
| Stage | (%) | pH | (%) | pH | (%) | pH |
| HNV | 3.87 | 5.49 | 3.87 | 5.49 | 3.87 | 5.49 |
| After treating | 3.7 | 5.51 | 3.69 | 5.49 | 3.70 | 5.50 |
| in stage-1 with | | | | | | |
| HPC GAC | | | | | | |
| After treating | 3.75 | 5.46 | 3.76 | 5.49 | 3.76 | 5.38 |
| in stage-2 with | | | | | | |
| BGX GAC | | | | | | |
| Final product | 3.8 | 5.42 | 3.74 | 5.48 | 3.77 | 5.45 |
| filtered | | | | | | |

TABLE 17
Reduction in odor causing compounds in final filtered product as determined
by headspace analysis (Negative values represent percentage reduction)

| | | HNV | Repetition 1 | | Repetition 2 | | Mean |
|---|---|---|---|---|---|---|---|
| | | Conc. | Conc. | Reduction | Conc. | Reduction | Reduction |
| | Compounds | (ng/mL) | (ng/mL) | (%) | (ng/mL) | (%) | (%) |
| 1 | acetaldehyde | 30 | 22 | −27 | 16 | −48 | −37 |
| | (estimated) | | | | | | |
| 2 | 2-methylpropanal | 11 | 3 | −69 | 3 | −77 | −73 |
| 3 | methyl acetate | 262 | 263 | 0 | 241 | −8 | −4 |
| 4 | ethyl acetate | 12683 | 4349 | −66 | 5560 | −56 | −61 |
| 5 | 2-methylbutanal | 0 | | −100 | | −100 | −100 |
| | (estimated) | | | | | | |
| 6 | 3-methylbutanal | 1 | | −100 | | −100 | −100 |
| | (estimated) | | | | | | |
| 7 | ethanol (saturated) | 7009 | 8313 | 19 | 5507 | −21 | −1 |
| 8 | 2,3-butanedione | 4224 | 96 | −98 | 43 | −99 | −98 |
| 9 | 2,3-pentanedione | 9 | | −100 | | −100 | −100 |
| 10 | methyl pyrazine | 148 | | −100 | | 0199 | −100 |
| 11 | 3-hydroxy-2- | 1304 | 1613 | 24 | 1002 | −23 | 0 |
| | butanone | | | | | | |
| 12 | 2,5- | 49 | | −100 | | −100 | −100 |
| | dimethylpyrazine | | | | | | |
| 13 | 2,6- | 35 | | −100 | | −100 | −100 |
| | dimethylpyrazine | | | | | | |
| 14 | ethyl pyrazine | 12 | | −100 | | −100 | −100 |
| | (estimated) | | | | | | |
| 15 | 2,3- | 24 | | −100 | | −100 | −100 |
| | dimethylpyrazine | | | | | | |
| | (estimated) | | | | | | |
| 16 | 2-ethyl-6- | 14 | | −100 | | −100 | −100 |
| | methylpyrazine | | | | | | |
| | (estimated) | | | | | | |
| 17 | 2-ethyl-5- | 8 | | −100 | | −100 | −100 |
| | methylpyrazine | | | | | | |
| | (estimated) | | | | | | |
| 18 | Trimethylpyrazine | 101 | | −100 | | −100 | −100 |
| 19 | 2,6-diethylpyrazine | 0 | | −100 | | −100 | −100 |
| | (estimated) | | | | | | |
| 20 | 3-ethyl-2,5- | 1 | | −100 | | −100 | −100 |
| | dimethylpyrazine | | | | | | |
| 21 | 2-ethyl-3,5- | 4 | | −95 | | −97 | |
| | dimethylpyrazine | | | | | | |
| 22 | tetramethylpyrazine | 8 | 0 | −99 | 0 | −99 | −99 |
| | (estimated) | | | | | | |
| 23 | benzaldehyde | 45 | 4 | −90 | 4 | −91 | −91 |

TABLE 18
Appearance and odor characteristics of the final filtered products

| Product | Color | Odor |
|---|---|---|
| HNV | clear, brown | vinegar > ethyl acetate > |
| | | malty/nutty > dairy/buttery |
| Two stage treated product: | clear | mild fruity (low vinegar note) |
| Repetition 1 | | |
| Two stage treated product: | clear | mild vinegar > fruity |
| Repetition 2 | | |

As shown above, particularly in Table 17, the process can be configured to remove all (about 100% reduction) or substantial (75 to 95%) pyrazines compounds responsible for broth smell and dione compounds responsible for “fingernail polish remover and buttery/dairy” flavor notes without reducing the total acetate content.

As shown above, the present disclosure provides processes for producing colorless, odorless neutralized vinegar products that may be used, for example, in the food industry, such as for seafood, meat and poultry, pet food, condiments, fruits and vegetables, as consumer-friendly antimicrobials without affecting the appearance and flavor of the product.

While there have been shown and described fundamental novel features of the disclosure as applied to the preferred and exemplary embodiments thereof, it will be understood that omissions and substitutions and changes in the form and details of the disclosure may be made by those skilled in the art without departing from the spirit of the disclosure. Moreover, as is readily apparent, numerous modifications and changes may readily occur to those skilled in the art. For example, any feature(s) in one or more embodiments may be applicable and combined with one or more other embodiments. Hence, it is not desired to limit the present disclosure to the exact construction and operation shown and described and, accordingly, all suitable modification equivalents may be resorted to falling within the scope of the present disclosure as claimed. It is the intention, therefore, to be limited only as indicated by the scope of the claims appended hereto.

What is claimed is:

1. A method for removing colored and off-flavored compounds from buffered vinegar, comprising: pumping buffered vinegar to be treated upwards through one or more vertically oriented activated carbon beds, collecting an effluent from a top of the one or more vertically oriented activated carbon beds, and filtering the collected effluent to remove entrained particles of activated carbon to obtain treated buffered vinegar.

2. The method of claim 1, wherein the one or more vertically oriented activated carbon beds comprises one or more columns having a bed of granulated activated carbon (GAC).

3. The method of claim 2, wherein multiple columns are used, and the columns are arranged in series.

4. The method of claim 2, wherein the buffered vinegar to be treated enters a lower part of the one or more columns into a plenum chamber where a perforated or porous distributor plate at a top of the plenum chamber separates the plenum chamber from the bed of GAC and uniformly distributes the buffered vinegar to be treated throughout a whole cross-sectional area of the bed of GAC.

5. The method of claim 1, wherein the buffered vinegar to be treated is pumped through the one or more vertically oriented carbon beds at a flow rate equivalent to an empty bed contact time (EBCT) of at least 70 minutes.

6. The method of claim 2, wherein, prior to pumping the buffered vinegar to be treated, GAC is wetted with an 5-10% (w/w) aqueous solution of 300 grain vinegar followed by draining an excess of the solution to obtain wetted GAC, and then the wetted GAC is filled into the one more columns to form the bed of GAC.

7. The method of claim 1, wherein a mass ratio of acetate ions in the treated buffered vinegar to that in the buffered vinegar to be treated is from 1:1 to 1:0.9.

8. The method of claim 1, wherein a total acetate content (as a mass percent of acetate ions) in the buffered vinegar to be treated ranges from 20 to 30 percent.

9. The method of claim 8, where the acetate ions are derived from unreacted acetic acid and acetate salts produced when vinegar is buffered using sodium and/or potassium bicarbonate and/or sodium and/or potassium carbonate to obtain the buffered vinegar to be treated.

10. The method of claim 1, wherein the method is terminated when the effluent is substantially clear when judged visually or when measured with a spectrophotometer it exhibits an absorbance at 260 nm lower than 0.6.

11. The method of claim 1, wherein the activated carbon is produced from coconut, wood charcoal, or coal.

12. The method of claim 2, wherein multiple columns are used, and each column is filled with a different GAC to achieve a different EBCT in each column.

13. The method in claim 12, where each column is filled with a same weight of dry GAC.

14. The method of claim 2, wherein multiple columns are used, and the multiple columns comprise a set 1 of a number “nc” of columns filled with coal GAC produced from coal and a set 2 of a number “nw” of columns filled with wood GAC produced from wood, and a corresponding time of contact equals “nc”×EBCT for the coal GAC and “nw”×EBCT for the wood GAC, to allow for selective separation of unwanted compounds in the buffered vinegar to be treated.

15. The method of claim 2, where the one or more columns are filed with a GAC made from a carbonaceous material other than coal, coconut, or wood.

16. A batch process comprising: contacting a mixture of a specific ratio of activated carbon to buffered vinegar to be treated by weight, holding the mixture at ambient temperature for a predetermined time needed to obtain color clarity or sufficient removal of undesirable compounds from the buffered vinegar to be treated, and then filtering the buffered vinegar to remove particles of activated carbon.
